(19) United States
(12) Patent Application Publication
(10) Pub. No.: US 2024/0196796 A1
(43) Pub. Date: Jun. 20, 2024

(54) ADAPTER UNIT FOR A SELF-PROPELLED FORAGE HARVESTER TO ATTACH AN ATTACHMENT DESIGNED FOR A COMBINE HARVESTER

(71) Applicant: CLAAS Omaha Inc., Omaha, NE (US)

(72) Inventors: Christopher Miller, Lincoln, NE (US); Seth Zentner, Johnson, NE (US); Kevin Wilkening, La Vista, NE (US); Carsten Grove, Beelen (DE); Udo Beschorn, Harsewinkel (DE)

(73) Assignee: CLAAS Omaha Inc., Omaha, NE (US)

(21) Appl. No.: 18/085,103

(22) Filed: Dec. 20, 2022

(51) Int. Cl. A01D 43/08

(52) U.S. Cl. CPC A01D 43/085; A01D 43/082; A01D 43/088

(57) ABSTRACT

A self-propelled forage harvester is disclosed. The self-propelled harvester includes a mounting device having a feeder for harvested material and an adapter unit that is detachably arranged on the mounting device. The adapter unit is configured to mount and adapt an attachment designed for a combine harvester, with the adapter unit comprising a control and regulating module that is configured to perform control and regulating functions specific to the combine harvester for setting operating parameters of the mounted attachment.

### TECHNICAL FIELD

The present invention relates to a self-propelled forage harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Self-propelled forage harvesters may include a mounting device having a feeder or feed means for harvested material, on which different attachments designed for operation on or with a forage harvester are arranged. Example attachments include, for example, a corn header or a pick-up. A control device of the forage harvester may be configured to actuate functional elements that are arranged or positioned on the attachment and which serve to drive and/or execute adjusting movements of components provided on the attachment, through which harvested material is harvested (e.g., cut and fed to the feeder).

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 shows a schematic representation of a self-propelled forage harvester in a side view;

FIG. 2 shows a schematic representation of an attachment designed for a combine harvester in a top view;

FIG. 3 shows a schematic side view of a chopping device of the attachment designed as a picking device according to FIG. 2;

FIG. 4 shows a schematic partial view of the forage harvester with the attachment adapted by an adapter unit;

FIG. 5 shows a schematic partial view of the forage harvester with a foldable attachment;

FIG. 6 shows a schematic representation of a control and regulating module of the adapter unit;

FIGS. 7a-b show schematic representations of the adapter unit in a side view in a first longitudinally inclined position in FIG. 7a and in a second longitudinally inclined position in FIG. 7b; and

FIG. 8 schematically shows a simplified partial perspective view of the adapter unit from behind.

### DETAILED DESCRIPTION

As discussed in the background, self-propelled forage harvesters may include a mounting device having a feeder or feed means for harvested material, on which multiple different attachments (e.g., a corn header or a pick-up) may be arranged. Deviating from this, attachments may also be arranged or positioned on the forage harvester which are originally intended for operation on a self-propelled combine harvester. For example, instead of the corn header, which pulls in crops grown in row crops such as corn as a whole, a corn picker may be used as an attachment designed for a combine harvester, which essentially feeds the fruiting stalks of the corn plant to the feeder of the forage harvester for further processing, while stalks and husks remain in the field.

In addition to components that differ at least in part from one another, attachments for forage harvesters differ from those for combine harvesters, for example, in their dimensions in the region of the connection to the respective mounting device of the forage harvester and combine harvester. Among other things, combine harvesters have a larger feed width of their mounting device than a forage harvester. In order to also be able to operate an attachment designed for a combine harvester on a forage harvester, an adapter unit may be detachably arranged or positioned on the mounting device, which may be configured to receive and adapt an attachment designed for a combine harvester. DE 20 2007 011 411 U1 discloses a forage harvester with an adapter unit. The adapter unit disclosed in DE 20 2007 011 411 U1 has a housing frame attached to the mounting device of the forage harvester and a front frame that may be pivoted relative to the housing frame. The front frame may be pivoted about an axis running transverse to the longitudinal axis of the forage harvester, wherein a pivoting angle to be set is specified by spindles connecting the housing frame and the front frame.

Depending on the type of attachment designed for the combine harvester, specific functions for moving and/or adjusting the attachment and/or its components cannot be directly controlled by a control device of the forage harvester. This may result in significant disadvantages during harvesting when operating the forage harvester with the attachment of the combine harvester adapted or modified by the adapter unit.

Thus, in one or some embodiments, a self-propelled forage harvester is disclosed that avoids the disadvantages of the prior art, such as a simplified and/or more flexible adaptation of an attachment designed for the combine harvester is enabled, which may also at least reduce restrictions in the control from the forage harvester.

In one or some embodiments, a self-propelled forage harvester is disclosed that comprises a mounting device having a feeder or a feed means for harvested material. Further included is an adapter unit that is configured to be detachably arranged or positioned on the mounting device of the forage harvester. Specifically, the adapter unit is configured to mount and adapt an attachment designed for a combine harvester. In one or some embodiments, the adapter unit comprises a control and regulating module which is configured to perform one or more control and/or regulating functions specific to a combine harvester for setting operating parameters of the mounted attachment. The adapter unit comprises the control and regulating module which enables actuation and/or regulation of an attachment that is adapted (via the adapter unit) to a forage harvester and designed for a combine harvester in the same or substantially the same way as is possible by a combine harvester, without the forage harvester itself comprising or having to include the module necessary for these control and regulating processes. In this regard, the forage harvester need not be adapted or modified. Instead, the adapter unit is configured to provide the interface between the attachment (designed for a combine harvester) on one side and the forage harvester on the other side.

In one or some embodiments, the control and regulating module arranged or positioned on the adapter unit is configured to perform the one or more control and regulating functions typically performed by a control device of the combine harvester (e.g., one function comprises controlling the attachment), which are not provided by a control device arranged or positioned in or on the forage harvester or which cannot be implemented or may only be implemented with great effort (e.g., with considerable changes to the forage harvester itself). In this regard, the adapter unit may perform the one or more control and regulating functions instead of performed by the forage harvester itself. In one particular example, the control and regulating module may comprise at least one computing unit and at least one memory unit. One or more software modules may be stored in the at least one memory unit. The at least one computer unit may be configured to execute the one or more software modules stored in the at least one memory unit.

In particular, the control and regulating module may be configured to actuate elements on one or both of the attachment or the adapter unit including any one, any combination, or all of: electrically operated element(s) on one or both of the attachment or the adapter unit; hydraulically operated element(s) on one or both of the attachment or the adapter unit; or driven functional elements on one or both of the attachment or the adapter unit. In one or some embodiments, functional elements of the attachment and/or the adapter unit may be any one, some, or all parts or components whose controlling to set or adjust them influences the operation or mode of operation of the attachment and/or the adapter unit. Thus, the setting or adjustment makes it possible to control, such as optimize, the execution of the harvesting process by the attachment arranged or positioned on the forage harvester and designed for operation on a combine harvester, although the forage harvester itself does not have the control and regulating functions required for this.

In one or some embodiments, a singular coupling device may be arranged or positioned on the adapter unit and may be configured for the joint hydraulic and electrical connection of the control and regulating module to the front attachment. The coupling device may be multifunctional in design (e.g., some or all control and regulating functions, such as both hydraulic and electrical, may be realized by a single plug-in connection, formed by two complementary coupling elements, between the control and regulating module of the adapter unit and the attachment). The singular coupling device has the advantage of simplifying and standardizing the connection of an attachment to the control and regulating module. In particular, the risk of incorrect connection assignments may be reduced or eliminated if the complementary coupling elements of the coupling device have shapes which may only be joined together in one way. DE 195 36 345 A1, which is incorporated by reference herein in its entirety, discloses a coupling device.

Furthermore, the control and regulating module may be configured for connection to a hydraulic system of the forage harvester. The control and regulating module may therefore function as an interface which supplies the hydraulically operated and/or driven functional elements with a hydraulic fluid flow and controls or regulates them. For this purpose, a valve block may be provided on the attachment and may be connected to the control and regulating module by the singular coupling device.

In one or some embodiments, the control and regulating module may be connected by at least one line to at least one control command generating device of the forage harvester. In one or some embodiments, a control command-generating device of the forage harvester may be at least one operating element in a driver's cab of the forage harvester. For example, any one, any combination, or all of a switch, pushbutton, a multifunction handle, or a touch-sensitive screen may be considered as a control element. In this case, by using the singular coupling device, the forage harvester may provide the necessary hydraulic and/or electric control elements from the driver's cab via the connection (which may be wired and/or wireless) to the adapter unit so that the attachment functions desired by an operator of the forage harvester may be used.

In one or some embodiments, the control and regulating module may be configured to receive and evaluate sensor signals from at least one sensor arranged or positioned on the attachment. In particular, one or several sensors may be arranged or positioned on the attachment. Several different sensors may be configured to detect different control or regulation variables that are used to set, adjust, and/or monitor operating parameters. In one or some embodiments, at least one sensor may be designed as a distance sensor, for example, in order to monitor a distance to be maintained between the attachment and the ground. At least one sensor may detect a crop edge and/or a plant row. Depending on the type of attachment, various types of sensors may be arranged or positioned on the attachment to set, adjust, and/or monitor the various operating parameters. In one or some embodiments, the control and regulating module may use the sensor signals (e.g., the sensor signals may be in the form of sensor data generated by the one or more sensors on the attachment that may be transferred, such as wired and/or wirelessly to the control and regulating module) to evaluate and control the functionality of the attachment. In one or some embodiments, the at least one sensor may be contacting or non-contacting. In a specific embodiment, a combination of contacting or non-contacting sensors may be used to detect individual control or regulating variables.

Alternatively, or in addition, the control and regulating module may be configured to generate control commands depending on the evaluation of the sensor signals, and to transmit them to at least one of the functional elements arranged or positioned on the adapter unit and/or on the attachment in order to actuate it.

Alternatively, or in addition, the control and regulating module may be configured to generate control commands depending on the evaluation of the sensor signals, and to transmit them to a control device of the forage harvester, which, in turn, responsive to receiving the control commands, the control device of the forage harvester may be configured to automatically perform one or more operations, such as automatically steer the forage harvester along a crop edge and/or at least one crop row. Using at least one suitable sensor, for example an optical sensor and/or a touch sensor, the position of the crop edge and/or a crop row may be detected, along which the forage harvester may be automatically guided by the control device or a control module stored in the control device of the forage harvester. Thus, in one embodiment, the control and regulating module on the adapter unit may include the intelligence to make one or more determinations, such as determining a crop edge and/or determining a crop row. In turn, the control and regulating module may send one or more commands to the forage harvester in order for the control device resident on the forage harvester to execute those commands in order to control one or more operations of the forage harvester (e.g., automatic steering of the forage harvester).

In one or some embodiments, the attachment may comprise a central segment and at least two outer segments which are articulated to the central segment, wherein the outer segments may be pivotable about substantially horizontally extending pivot axes using functional elements designed as linear actuators. Further, the control and regulating module may be configured to actuate the linear actuators of the multi-part attachment in order to switch the pivotable segments of the attachment alternately between an unfolded working position and a folded transport position. In their transport position, the at least three segments of the multi-part attachment may be switched into a position in which the attachment does not exceed a predetermined permissible width, such as a permissible width of 3 m, when driving on public roads. For this purpose, the two outer segments may be pivoted at least by an angle of 90° relative to the inner segment, so that in their transport position, the outer segments are oriented essentially perpendicular to the inner segment. The outer segments may also be pivoted by an angle of more than 90° so that, in their transport position, they are positioned above the inner segment at least sectionally overlapping each other.

In one or some embodiments, the control and regulating module may be configured to actuate functional elements arranged or positioned on the adapter unit and designed as actuators, such as linear actuators, for adapting or modifying a transverse inclination and/or a longitudinal inclination of the attachment. This may allow the inclination of the attachment to be adjusted in the direction of travel in order to follow undulating ground unevenness along the direction of travel. By adjusting the transverse inclination, the inclination of the attachment transverse to the direction of travel may be varied in order to be able to compensate for ground unevenness transverse to the direction of travel.

In particular, the attachment to be adapted or modified may be configured to harvest corn, wherein the attachment has a plurality of infeed and picking devices, each comprising a picking gap formed by two spaced picking plates, picking rollers arranged or positioned in pairs below the picking gap and driven in opposite directions, and a chopping device arranged or positioned below the picking rollers.

The control and regulating module may be configured to actuate a functional element designed as a picking plate adjuster to change the width of the picking gap. By adjusting the picking gap width, it is possible to react to changes in the diameters of the harvested material stalks passing through the picking gap. By assigning a linear actuator as an automatically operating picking plate adjuster to at least one of the picking plates of a picking device which work together in pairs, automatic adjustment to different stalk diameters may be made possible. Particularly sensitive fine adjustment may be achieved if each picking plate is assigned such a linear actuator as picking plate adjuster.

Moreover, the control and regulating module may be configured to actuate functional elements of the chopping devices designed as a driver or a drive means. The control and regulating module may be used to control the driver or the drive means, such as to switch the driver or the drive means of the chopping devices on and/or off. With a driver or drive means of the chopping devices that are designed as electric motors, the control and regulating module may also be configured to vary the drive speeds of the chopping devices. In this regard, the control and regulating module may control one or more aspects of the driver or the drive means.

In one or some embodiments, the functional elements of the attachment and the adapter unit may be operated or driven entirely electrically, wherein the control and regulating module is configured to actuate these functional elements entirely electrically.

In one or some embodiments, the control and regulating module may have a data interface for transferring software modules to a memory unit of the control and regulating module, through which the control and regulating functions may be adapted or modified to different attachments. In one or some embodiments, the control and regulating module comprises a computer unit that executes one or more software modules stored in the memory unit in order to perform the specific control and regulating functions of the adapted attachment independently of the forage harvester's control device. The interchangeability or storage of several software modules using the data interface may enable easier adaptation to different types of attachments, and/or attachments from different manufacturers that are connected to the adapter unit.

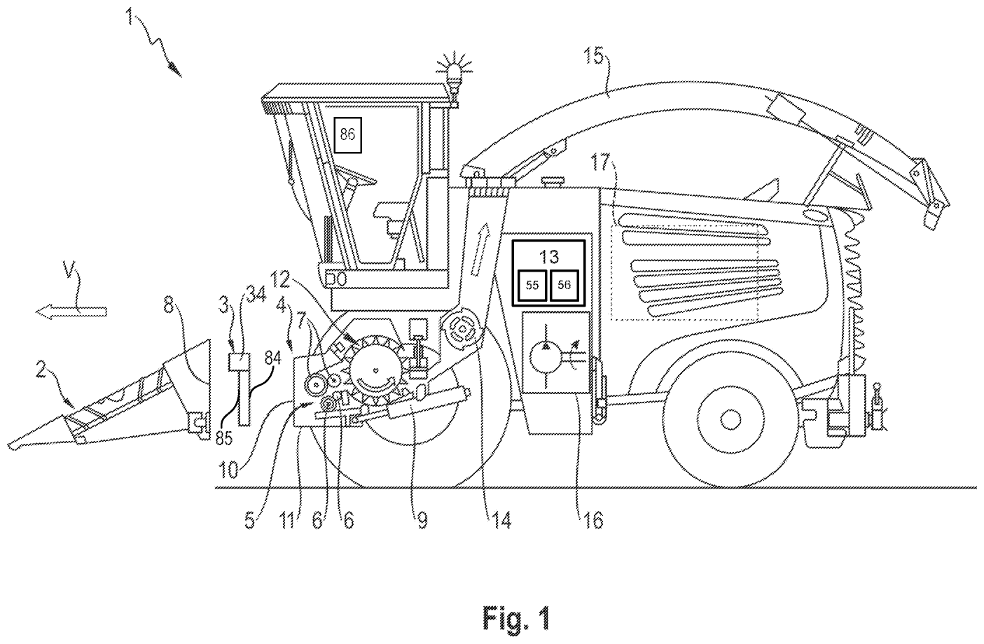

Referring to the figures, in FIG. 1, a schematic representation of a self-propelled forage harvester 1 is shown in side view with an attachment 2 arranged or positioned thereon using an adapter unit 3. US Patent Application Publication No. 2020/0359563 A1, incorporated by reference herein in its entirety, discloses a forage harvester. For better illustration, the attachment 2 and the adapter unit 3 are shown detached from each other, with the adapter unit 3 including a forage harvester connector 84 configured to detachably connect to the mounting device 4 of the forage harvester 1 and an attachment connector 85 configured to detachably connect to the attachment 2. As discussed in more detail below, the attachment 2 is configured for operation with a combine. Example attachments configured for operation with a combine are disclosed in U.S. Pat. Nos. 5,556,042, 8,578,689 and US Patent Application Publication No. 2013/0296005 A1, each of which are incorporated by reference herein in their entirety.

Various forage harvester connectors 84 and attachment connectors 85 are contemplated. In one or some embodiments, the forage harvester connector 84 comprises a frame element with an attachment device configured to connect to the mounting device 4 of the forage harvester 1. The attachment device may comprise any one, any combination, or all of bolts, clamps, or fasteners that may be resident on one of the forage harvester connector 84 or the mounting device 4 with mating attachments (e.g., holes, clamps, or the like) resident on the other of the forage harvester connector 84 or the mounting device 4. In one or some embodiments, the attachment connector 85 comprises a frame element with an attachment device configured to connect to the attachment 2. The attachment device may comprise any one, any combination, or all of bolts, clamps, or fasteners that may be resident on one of the attachment connector 85 or the attachment 2 with mating attachments (e.g., holes, clamps, or the like) resident on the other of the attachment connector 85 or the attachment 2.

In one or some embodiments, the forage harvester 1 comprises a channel-shaped mounting device 4 for mounting the attachment 2. The mounting device 4 has a feed means 5 (or a feeder) for harvested material, which may be designed with a plurality of rollers, such as upper and lower feed rollers 6, 7 arranged or positioned in pairs that are arranged or positioned in a feed housing 11. A chopping device 12 is arranged or positioned downstream of the feed rollers 6, 7. In one or some embodiments, the attachment 2 is designed as a so-called corn picker, which is typically used on a combine. The forage harvester 1 further comprises a control device 13 which may serve, among other things, to actuate the working units of the forage harvester 1.

Control device 13 may include any type of computing functionality, such as at least one processor 55 (which may comprise a microprocessor, controller, PLA, or the like) and at least one memory 56. The memory 56 may comprise any type of storage device (e.g., any type of memory). Though the processor 55 and the memory 56 are depicted as separate elements, they may be part of a single machine, which includes a microprocessor (or other type of controller) and a memory. Alternatively, the processor 55 may rely on memory 56 for all of its memory needs.

The processor 55 and memory 56 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. The above discussion regarding the at least one processor 55 and the at least one memory 56 may be applied to other devices, such as the control and regulating module 34, discussed further below.

Further working units of the forage harvester 1 may include, in addition to the feed means 5 and the chopping device 12, a post-accelerator 14, a discharge chute 15 adjustable about a horizontal and vertical axis, a hydraulic system 16 which is symbolized representatively by a pump, and a drive device 17 designed as an internal combustion engine.

Harvested material collected by the attachment 2 is fed to the feed rollers 6, 7 through a rear outlet opening 8 in the frame of the attachment 2 to a front opening 10 in the feed housing 11 of the mounting device 4, and is supplied for further processing to subsequently arranged or positioned working units of the forage harvester 1, first to the chopping device 12. The reference sign V denotes a direction of travel of the harvester 1 in which the harvested material is picked up. In one or some embodiments, the mounting device 4 is pivotable by at least one hydraulic cylinder 9, which may be connected to the hydraulic system 16, about an axis of rotation extending horizontally and/or transversely to the direction of travel V in order to be able to adjust the height of the attachment 2 relative to the ground.

To improve the nutrient content of animal feed, “ear corn” is increasingly being harvested rather than the whole corn plant. This means that only the corn cobs are harvested and processed into animal feed, rather than the whole plant. The specific function of a combine harvester is to harvest and process only the corn cobs. With the adapter unit 3 for attaching the attachment 2 of a combine harvester which is designed for harvesting corn cobs, for example, to the forage harvester 1, the corn cobs may be harvested and brought into the forage harvester 1 for processing. Similarly, small grain crops such as oats or wheat may be harvested with an attachment 2 normally designed for and used on a combine harvester. With the adapter unit 3 for attaching the attachment 2 designed for a combine harvester to the forage harvester 1, the harvested material may be cut directly and fed to the forage harvester 1 for processing.

In this respect, the adapter unit 3 has the task of enabling the detachable mounting of the attachment 2 to the forage harvester 1. An example adapter unit is disclosed in U.S. application Ser. No. 17/994,191, incorporated by reference herein in its entirety. In addition, the adapter unit 3 may be configured to adjust an inclination of the attachment 2 with respect to the mounting device 4 in the longitudinal and/or transverse direction, in order to likewise enable the functions of adjusting the inclination of the attachment 2 in the longitudinal and/or transverse direction which are possible on a combine. Adjusting the inclination of the attachment 2 in the longitudinal and/or transverse directions may be advantageous in terms of maintaining the flow of harvested material and the efficiency in the process of picking up the crop using the attachment 2.

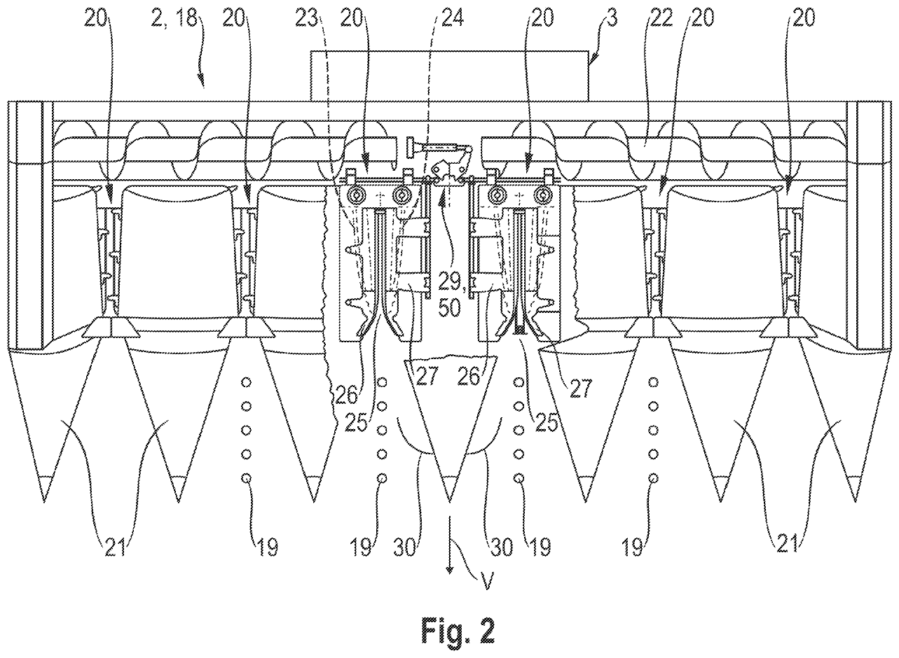

FIG. 2 schematically shows an attachment 2 that is designed for operation on a combine harvester and which is designed and configured as a picking device 18 for picking fruit stalks of stalked harvested material 19 which is cultivated in a row culture. In one or some embodiments, an attachment designed for a combine harvester is understood as meaning that a control unit of the combine harvester comprises specific control and regulating functions for setting operating parameters for the attachment 2, which may be required, inter alia, for actuating the attachment 2.

In the following, reference is always made to an attachment 2 designed for a combine harvester, which is operated on the forage harvester 1.

The attachment 2, which may be designed as a picking device 18, is configured for picking stalked harvested material 19 and may have a plurality of feed and picking devices 20. In the embodiment in FIG. 2, six feed and picking devices 20 are arranged or positioned next to each other and transverse to the direction of travel V. Deviating from this, the number of feed and picking devices 20 may be less (e.g. four feed and picking devices 20), or more (e.g. eight or twelve feed and picking devices 20). In this regard, fewer or greater feed and picking devices are contemplated.

The feed and picking devices 20 may be at least partially covered at the top by divider hoods 21. In the rear area, the feed and picking devices 20 may be assigned a transverse conveying unit designed as a cross-feeding conveyor 22 which brings together the fruit stalks harvested by the feed and picking devices 20 in the middle and transfers them to the feed means 5 of the forage harvester 1, which may hold and drive the picking device 18 as a carrier vehicle. For this purpose, the picking device 18 may be attached to the forage harvester 1 via the adapter unit 3.

In one or some embodiments, each feed and picking device 20 is formed by picking rollers 23, 24 which cooperate in pairs (shown in dashed lines), wherein picking plates 26, 27, which likewise may cooperate in pairs, are associated with the picking rollers 23, 24 at the top and form a picking gap 25 between them. Above the picking plates 26, 27, conveying units designed as conveyor chains may be arranged or positioned in a manner known per se and convey the fruit stalks pulled off the picking plates 26, 27 when the stalks of the harvested material 19 are pulled through the picking gap 25 out of the region of the picking rollers 23, 24. For shredding the stalks of the harvested material 19, at least one chopping device 28 may be assigned to the bottom of the picking rollers 23, 24, which may work together in pairs, and which may shred the crop stalk gripped by the picking rollers 23, 24 into pieces, which may accelerate decomposition. In one or some embodiments, the picking plates 26, 27 are coupled to each other by a picking plate adjuster 29. The picking plate adjuster 29 may be operated in any one, any combination, or all: mechanically operated; hydraulically operated; electro-hydraulically operated; or electrically operated. Sensors 30 in the form of sensing bars may be arranged or positioned on a divider hood 21 between two picking gaps 25, which sensors may serve to detect the stalked harvested material 19 standing in rows.

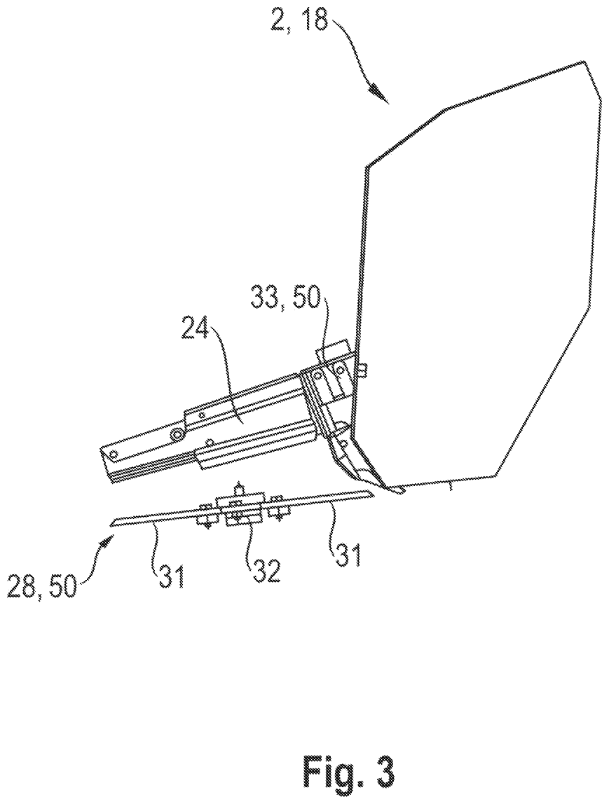

FIG. 3 schematically shows a side view of the chopping device 28 of the picking device 18. In one or some embodiments, the particular chopping device 28 may comprise blades 31 rotating about a vertical axis, which may be attached to a blade holder 32. The particular feed and picking devices 20 may have a picker gear 33, which may transmit a torque provided by a drive shaft of the attachment 2 to the picking rollers 23, 24.

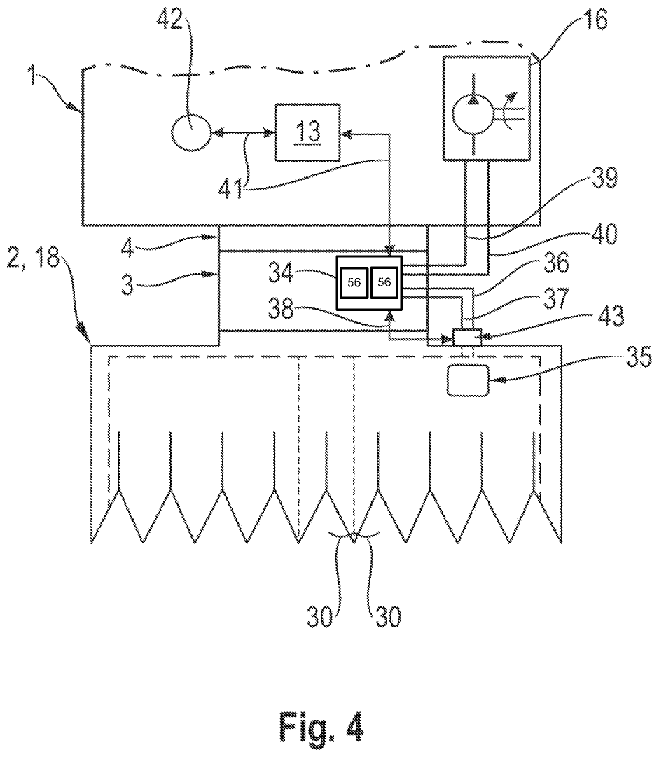

The illustration in FIG. 4 schematically shows a partial view of the forage harvester 1 with the attachment 2 (which is the picking device 18) adapted or modified by the adapter unit 3. In one or some embodiments, the adapter unit 3 comprises a control and regulating module 34 which is configured to perform control and regulating functions specific to the combine harvester for setting operating parameters of the mounted attachment 2.

Control and regulating module 34 may comprise any type of computing functionality. As shown, control and regulating module 34 includes at least one processor 55 and at least one memory 56 as representative of the computing functionality. Reference is made to the above discussion regarding control device 13 with regard to the at least one processor 55 and the at least one memory 56.

In one or some embodiments, the control and regulating module 34 may reside on the adapter unit 3 and may be in communication with the attachment 2 in one or more ways, such as in one or both of communication (e.g., wired and/or wireless communication) with the attachment 2 (e.g., transmit communications (e.g., commands) to and/or receive communications (e.g., sensor readings) from the attachment); or fluid communication (e.g., hydraulic feedline 36 (alternatively termed a hydraulic supply line) and/or hydraulic discharge line 37) with the attachment 2. Alternatively, or in addition, the control and regulating module 34, which may reside on the adapter unit 3, may be in communication with the forage harvester 1 in one or more ways, such as in one or both of communication (e.g., wired and/or wireless communication) with the forage harvester 1 (e.g., transmit communications (e.g., status communication and/or commands) to and/or receive communications from the attachment); or fluid communication (e.g., hydraulic feedline 39 and/or a hydraulic discharge line 40) with the forage harvester 1. In this regard, the adapter unit 3 may be configured as an interface for one or both of communications or hydraulics (e.g., control the supply of hydraulic fluid and/or discharge of hydraulic fluid to the attachment 2) between the forage harvester 1 and the attachment 2.

Specifically, in one or some embodiments, the control and regulating module 34 is connected to a central valve block 35 of the attachment 2 using a particular hydraulic feedline 36 and a hydraulic discharge line 37. In one or some embodiments, all valves of the attachment 2 required for hydraulic actuation may be integrated in the valve block 35. Using a signal line 38, the control and regulating module 34 may be connected to (and in communication with) the attachment 2 through one or more signals. In one or some embodiments, signal line 38 comprises a bi-directional signal line in which information, such as sensor data, is received from the attachment 2 and information, such as control signal(s) is transmitted from the control and regulating module 34 to the attachment 2. For example, using the signal line 38, sensor data may be received from the sensors 30 resident on the attachment, such as sensors 30 designed as sensing bars. In addition, electrical control signals may be transmitted to the valve block 35 using the signal line 38 in order for the control and regulating module 34 to control at least one aspect of the attachment 2, such as to electrically actuate at least one of the valves contained therein. Alternatively, or in addition, though shown at a wired connection, communication of the control and regulating module 34 with the attachment 2 may be wireless.

In one or some embodiments, the control and regulating module 34 is connected to the hydraulic system 16 of the forage harvester 1 using a hydraulic feedline 39 and a hydraulic discharge line 40 in order to supply the attachment 2 with hydraulic fluid. In one or some embodiments, a signal line 41 connects the control and regulating module 34 to the control device 13 of the forage harvester 1. Again, alternatively, or in addition, though shown as a wired connection, communication of the control and regulating module 34 with the control device 13 of the forage harvester 1 may be wireless. In one or some embodiments, the control and regulating module 34 is connected by at least one line, such as the signal line 41, to at least one control command generating device 42 of the forage harvester. A control command-generating device 42 of the forage harvester 1 may be an operating element or a control element in the driver's cab of the forage harvester 1. For example, operating elements or control elements may include any one, any combination, or all of: switch(es); button(s); multi-function handle(s); a touch-sensitive display device, or a touch screen.

As discussed above, the adapter 3 may be configured to control the flow of communication and/or the flow of fluid (e.g., hydraulic fluid) between the forage harvester 1 and the attachment 2. In one or some embodiments, the control and regulating module 34 may determine based on a communication from the adapter 3 (such as via signal line 38) to supply hydraulic fluid via hydraulic feedline 36 and/or to receive hydraulic fluid from hydraulic discharge line 37. Alternatively, the control and regulating module 34 may determine, based on sensing the fluid and/or fluid pressure at hydraulic discharge line 37, that hydraulic fluid is to be received from hydraulic discharge line 37. Still alternatively, the forage harvester 1 (e.g., control device 13) may send a communication to the control and regulating module 34 indicating that hydraulic fluid is to be supplied to or is to be received from the attachment 2. Thus, the control and regulating module 34 may determine whether to receive and/or send hydraulic fluid from/to one or both of the forage harvester 1 or the attachment 2 based on any one, any combination, or all of: a communication from the forage harvester 1; a communication from the attachment 2; or an independent determination by the control and regulating module 34 (e.g., based on sensor readings from one or more sensors).

In any of these instances, responsive to determining that hydraulic fluid is to be supplied (via hydraulic feedline 36 and/or via hydraulic feedline 39) to the attachment 2 and/or from the forage harvester 1, and/or to be received (via hydraulic discharge line 37 and/or via hydraulic discharge line 40) from the attachment 2 and/or to the forage harvester 1, the control and regulating module 34 may communicate with one or more parts of the attachment and/or the forage harvester 1 accordingly. As one example, responsive to the control and regulating module 34 determining to supply hydraulic fluid to the attachment 2, the control and regulating module 34 may communicate with the forage harvester 1 (e.g., control device 13) in order for the forage harvester 1 to supply hydraulic fluid via hydraulic feedline 39. Alternatively, or in addition, responsive to the control and regulating module 34 determining to receive hydraulic fluid from the attachment 2, the control and regulating module 34 may communicate with the forage harvester 1 (e.g., control device 13) in order for the forage harvester 1 to source hydraulic fluid via hydraulic discharge line 40. In this regard, the control and regulating module 34 may communicate with one or both of the forage harvester 1 and the attachment 2 in order to resolve and/or control the flow of hydraulic fluid between the forage harvester 1 and the attachment 2.

In one or some embodiments, to simplify the electrical and hydraulic connection of the attachment 2 to the adapter unit 3, a singular coupling device 43 is arranged or positioned on the adapter unit 3 and is configured for the common hydraulic and electrical connection of the control and regulating module 34 to the attachment 2. The coupling device 43 may also be referred to as a multi-coupler because of its suitability for joint hydraulic and electrical connection. The coupling device 43 has the advantage of standardizing and simplifying the connection of the attachment 2 designed for the combine harvester to the adapter unit 3. In addition, the risk of mixing up connections is reduced or avoided.

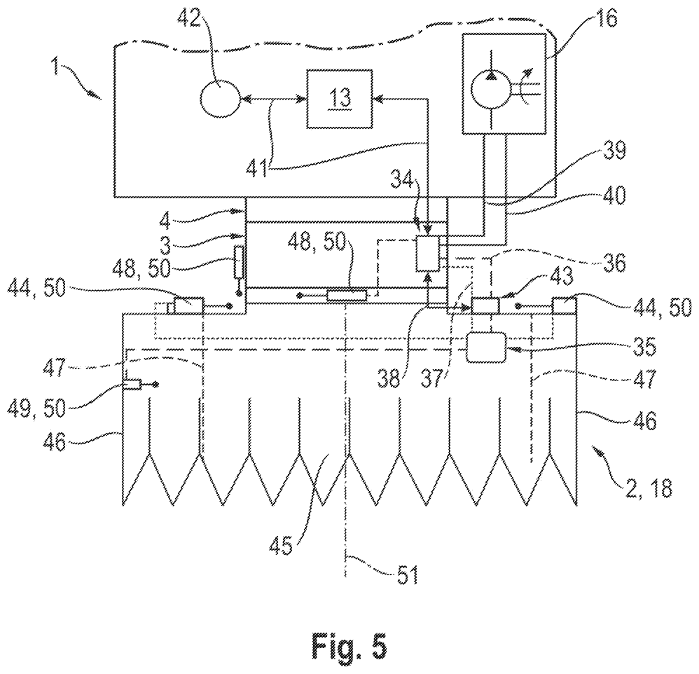

The illustration in FIG. 5 schematically shows a partial view of the forage harvester 1 with an attachment 2 designed to be foldable. In one or some embodiments, the attachment 2, which may also be designed as a picking device 18, comprises a central segment 45 and at least two outer segments 46, which may be articulated to the central segment 45. In one or some embodiments, the outer segments 46 are pivotable about substantially horizontally extending pivot axes 47 by functional elements 50 configured as linear actuators 44. The control and regulating module 34 of the adapter unit 3 may be configured to actuate the linear actuators 44 of the multi-part attachment 2 in order to transfer the pivoting segments 46 of the attachment 2 alternately between an unfolded working position and a folded transport position. In the folded transport position, the attachment 2 may have a maximum width that allows it to be carried along when the forage harvester 1 is traveling on the road. In this regard, an operator may enter, via a touchscreen 86 (illustrated in FIG. 1) a command to control the attachment 2, such as configuring the attachment 2 in the folded transport position and/or in the unfolded working position. The command entered via the touchscreen 86 may be transferred (e.g., wired and/or wirelessly) to the control device 13 of the forage harvester 1. Alternatively, or in addition, the control device 13, in combination with a driver assistance system, may determine automatically (e.g., based on analysis that the forage harvester is performing any one, any combination, or all of the following: traveling on a roadway; exiting the field; exiting a row of the field; entering the field; entering a row of the field) whether the attachment 2 should be in the unfolded working position or the folded transport position. In turn, the control device 13 may send one or more commands to the adapter unit 3. In response to receipt of the one or more commands from the control device 13, the control and regulating module 34 may send command(s) to actuate the linear actuators 44 of the multi-part attachment 2 in order to transfer the pivoting segments 46 of the attachment 2 alternately between an unfolded working position and a folded transport position.

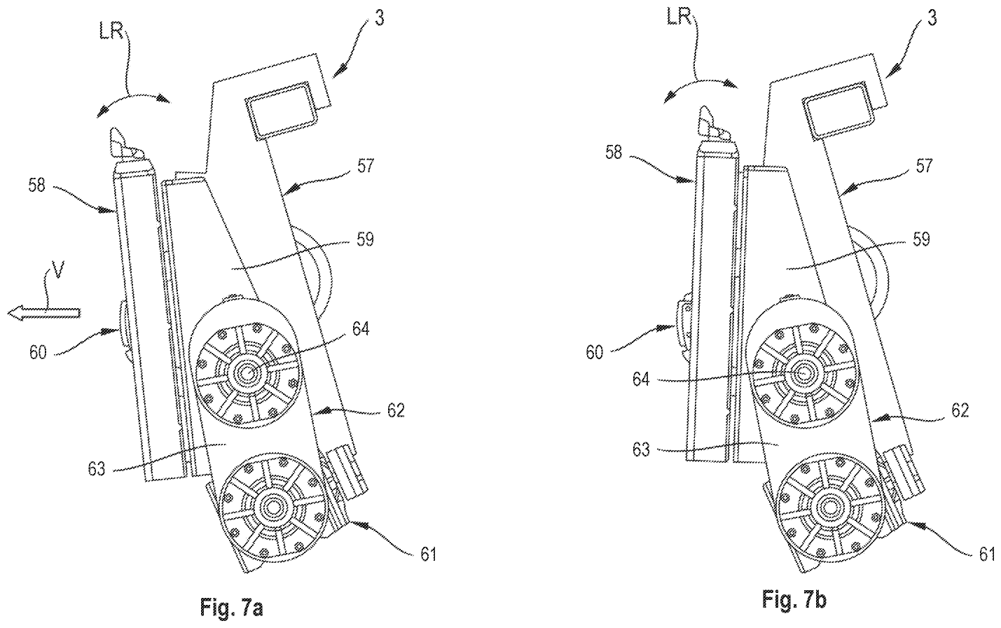

Alternatively or in addition, at least one further linear actuator 48 arranged or positioned on the adapter unit 3 enables the attachment 2 to swing about an axis 51 running parallel to the direction of travel V. The adapter unit 3 may be configured to set an inclination of the attachment 2 relative to the mounting device 4 in the transverse direction by actuating the at least one linear actuator 49. In this way, changes in the ground contour transverse to the direction of travel V may be compensated for. A further linear actuator 48 of the adapter unit 3 is used to set an inclination of the attachment 2 relative to the mounting device 4 in the longitudinal direction. For example, the adapter unit 3 may thus adjust in the longitudinal direction and/or in the transverse direction. An example of this is illustrated in FIGS. 7a-b and 8, discussed below.

In one or some embodiments, the control and regulating module 34 may be configured to determine whether (and how much) to adjust in one or both of the longitudinal direction and/or in the transverse direction. As one example, sensor data, which may be generated by sensor(s) 30, may indicate a distance of the attachment 2 to ground. Responsive to the control and regulating module 34 receiving the sensor data, the control and regulating module 34 may control the position of the attachment in one or both of the longitudinal direction or the transverse direction.

Furthermore, the control and regulating module 34 may be configured to actuate at least one functional element 50, designed as a linear actuator 49, of the picking plate adjuster 29 for changing the width of the picking gap 25. In one or some embodiments, the determination whether to change the width of the picking gap 25 is performed by the control device 13. For example, responsive to the control device 13 (via operator input and/or via automatic determination) determining to change the width of the picking gap 25, the control device 13 may send command(s) to the adapter unit 3. In turn, the adapter unit 3, via the control and regulating module 34, may send a command to actuate the linear actuator 49 of the picking plate adjuster 29 in order to change the width of the picking gap 25. Alternatively, or in addition, the adapter unit 3, such as the control and regulating module 34, may determine whether to change the width of the picking gap 25. In response to the adapter unit 3 determining to change the width of the picking gap 25, the control and regulating module 34 (without triggering or input from the forage harvester 1) may send the command to actuate the linear actuator 49 of the picking plate adjuster 29 in order to change the width of the picking gap 25.

Furthermore, the control and regulating module 34 may be configured to actuate the respective functional element 50, designed as a drive means or a driver, such as a picker gear 33, of the chopping device 28 of each feed and picking device 20. In particular, the control and regulating module 34 may be configured to control one or more aspects of the chopping device 28, such as to switch the chopping devices 28 on or off.

Generally speaking, the term functional elements 50 describes some or all parts or components of the attachment 2 and/or the adapter unit 3, the control of which to set or adjust them influences the operation or functioning of the attachment 2 and/or of the adapter unit 3. Functional elements 50 may therefore, inter alia, include the picking plate adjuster 29, the picker gear 33, the linear actuators 44, 48, 49 and the like. One or more aspects of the functional elements may vary. For example, any one, any combination, or all of the type, the number and/or the design of the functional elements 50 to be actuated by the control and regulating module 34 may vary with the type of attachment 2 to be adapted.

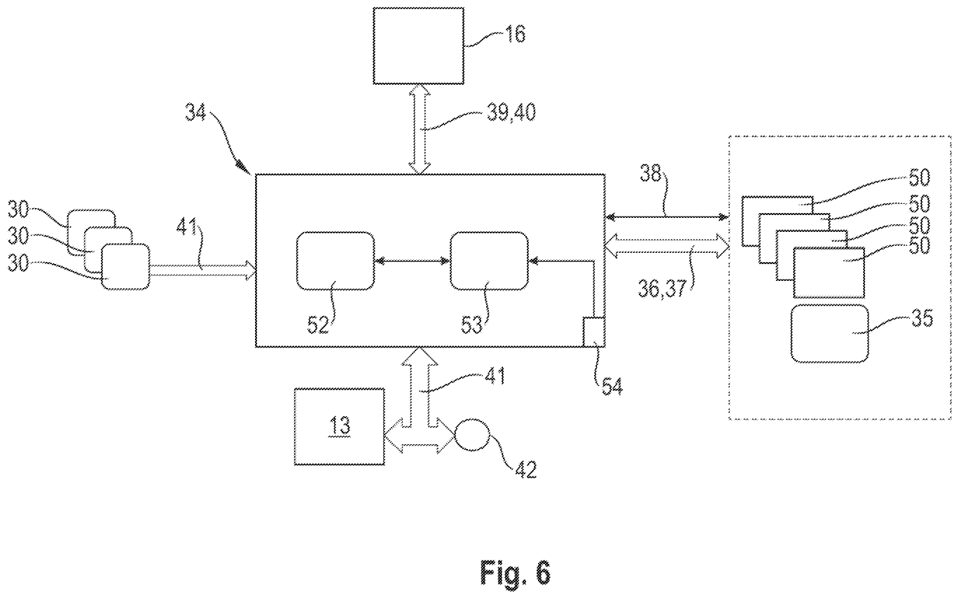

FIG. 6 shows a schematic representation of the control and regulating module 34 of the adapter unit 3 according to one aspect of the invention. The control and regulating module 34 comprises a computing unit 52 (which is an example of a controller, a processor, or the like) and a memory unit 53 (which is an example of a memory). Thus, FIG. 6 illustrates another manifestation of the computing functionality. Furthermore, a data interface 54 may be provided, which may serve for the wired and/or wireless transmission of software modules to the memory unit 53 of the control and regulating module 34. In this way, the stored control and regulating functions of the control and regulating module 34 may be adapted or modified to different attachment devices 2. In one or some embodiments, the computing unit 52 executes the software modules stored in the memory unit 53 in order to perform the specific control and regulating functions of the adapted front attachment 2 independently of the control device 13 of the forage harvester 1.

In one or some embodiments, the control and regulating module 34 is configured to actuate the electrically and/or hydraulically operated or driven functional elements 50 of the attachment 2 and/or the adapter unit 3. Using the control and regulating module 34, the drive means (e.g., picker gear 33) may be switched on and off as functional elements 50 of the chopping devices 28. With a drive means of the chopping devices 28 that is designed as an electric motor, the control and regulating module 34 may also be configured to vary the drive speeds of the chopping devices 28.

In one or some embodiments, the control and regulating module 34 may further be configured to actuate the functional elements 50 designed as linear actuators 44, 48, 49. In this case as well, the actuation may be electrical and/or hydraulic. In particular, the actuation of at least the linear actuators 44, 48, 49 designed as hydraulic cylinders may occur by using the valve block 35. Alternatively, the linear actuators 44, 48, 49 may be designed at least in part as electrically driven linear motors.

For actuating the adapter unit 3 and the attachment 2 arranged or positioned thereon, the control and regulating module 34 may be configured to receive and evaluate sensor signals from the at least one sensor 30 arranged or positioned on the attachment 2. The sensor 30 may, as previously explained, sense one or more aspects of the attachment, such as sensing bar(s) that serve to detect a crop edge or a plant row. Furthermore, the sensors 30 may sense hoops arranged or positioned on the underside of the attachment 2, which may serve to determine the distance to the ground. Other sensed aspects are contemplated. The control and regulating module 34 may analyze or evaluate the sensor signals generated by the sensors 30, thereby making it possible to adapt the longitudinal inclination and/or the transverse inclination of the attachment 2 to a changing ground contour by controlling the linear actuator 48 and/or the linear actuators 48 of the adapter unit 3. In this regard, in one or some embodiments, the control and regulating module 34 may be configured to make the determination whether and/or how to control one or more parts of the attachment based on the analysis of the control and regulating module 34 itself, without reliance on one or both of the control units or processors resident on the attachment 2 or the forage harvester 1. In such an instance, the forage harvester 1 need not be modified in order to use (via the adapter unit 3) the attachment 2 in its operations. Alternatively, the control and regulating module 34 may determine whether and/or how to control the attachment 2 based on the control units or processors resident on the attachment 2 or the forage harvester 1. Further, various sensors are contemplated. For example, sensors 30 may include any one, any combination, or all of: optical sensors; proximity sensors; or pressure sensors.

In one or some embodiments, the control and regulating module 34 is configured to evaluate the sensor signals received from the at least one sensor 30 and to generate control commands depending on the evaluation or analysis of the sensor signals. The control and regulating module 34 may transmit the generated control commands to at least one of the functional elements 50 arranged or positioned on the adapter unit 3 and/or on the attachment 2 in order to actuate it as intended. In one or some embodiments, the proper actuation of at least one of the functional elements 50 arranged or positioned on the adapter unit 3 and/or on the attachment 2 depends on the type of attachment 2.

In one or some embodiments, at least the functional elements 50 of the attachment 2 and the adapter unit 3 may be operated or driven entirely electrically. For this purpose, the control and regulating module 34 may be configured to actuate these functional elements 50 entirely electrically. The functional elements 50 may therefore be designed as linear motors or as electric motors, for example for driving the picking rollers 23, 24, as already explained above.

The control and regulating module 34 has been described above as the attachment 2 basically in the context of the picking device 18. The attachment 2 to be adapted using the adapter unit 3 may also be a grain cutting unit, which was originally designed for a combine harvester. The data interface 54 of the control and regulating module 34 offers the possibility of loading corresponding software modules into the memory unit 53 in order to be able to actuate the various attachments 2.

As discussed above, an example of the adapter unit 3 is disclosed in U.S. application Ser. No. 17/994,191, incorporated by reference herein in its entirety. FIGS. 7a-b illustrate schematic representations of the adapter unit 3 in a side view in a first longitudinally inclined position in FIG. 7a, and in a second longitudinally inclined position in FIG. 2b. The adapter unit 3 may comprise a stationary frame element 57 arranged or positioned stationary on the mounting device 4, and a movable frame element 58 that is movable relative to the stationary frame element 57. “Stationary” may mean that the stationary frame element 57 is arranged or positioned immovably but releasably on the mounting device 4. In this regard, the stationary frame element is an example of the forage harvester connector of the adapter unit 3 configured to detachably connect to the mounting device 4 of the forage harvester 1. In one or some embodiments, the relatively movable frame element 58 is designed to be adjustable relative to the stationary frame element 57 in a transverse direction about a virtual pendulum axis extending in the longitudinal direction of the mounting device 4, and about a horizontal pivot axis extending transversely to the longitudinal axis of the mounting device 4 in the longitudinal direction LR. The inclination of the relatively movable frame element 58 may be adjustable in the longitudinal direction LR substantially within a predetermined range (e.g., a range between ±2°; a range between ±3°; a range between ±4°; a range between ±5°; etc.). In this regard, the relatively movable frame element 58 is an example of an attachment connector configured to detachably connect to the attachment 2.

In FIG. 7b, the relatively movable frame element 58 has an inclination of 0° in the longitudinal direction LR relative to the stationary frame element 57. In this inclined position of the relatively movable frame element 58, the front side of the mounting device 4 and the rear outlet opening 8 in the frame of the attachment 2 enclose an angle determined by the design. This angle may ensure that the angle of inclination between the attachment 2 and the ground is optimal when the attachment 2 with the adapter unit 3 is attached to the harvester 1.

The variable adjustment of the inclination in the longitudinal direction LR may be advantageous because it allows improving or optimizing the angle between the attachment 2 and the ground under different harvesting conditions. For example, when the harvested material is high and stationary, the attachment 2 may be inclined towards the rear (e.g., towards the harvester 1) in order to make it easier for the attachment 2 to collect the harvested material. Furthermore, adjusting the inclination of the attachment 2 towards the rear may allow for greater clearance when the attachment 2 is to be loaded onto a transport trailer for transport. When the harvested material is lying on its side, the attachment 2 may be inclined more forward (e.g., towards the ground) to collect the harvested material more aggressively.

Furthermore, the illustrations in FIGS. 7a-b illustrate that the relatively movable frame element 58 sectionally encloses the stationary frame element 57 in the region of the pivot axis. For this purpose, the relatively movable frame element 58 has opposing side walls 59, of which only one is visible in the view in FIGS. 7a and 7b. An intermediate conveyor 60 may be arranged or positioned in the stationary frame element 57.

In one or some embodiments, an angular gear 61 is arranged or positioned on the stationary frame element 57, which may be arranged or positioned in a stationary manner on the mounting device 4, below the intermediate conveyor 60, which angular gear 61 has two coaxial output shafts which serve to drive two gearboxes 63 arranged or positioned opposite one another on the stationary frame element 57. The two gearboxes 63 may each be arranged or positioned in a housing 64. The respective housing 64 may extend substantially vertically in the direction of the intermediate conveyor 60, starting from the output shafts of the angular gear 61. The respective housing 64 may be fixed to the stationary frame element 57. An output shaft 65 of the respective gearbox 63 extending above and axially parallel to the output shafts of the angular gear 61 may extend outwardly. A drive shaft of the attachment 2 may be coupled to the respective output shaft 65 to drive its components. In one or some embodiments, the two gearboxes 63 may be designed as spur gearboxes.

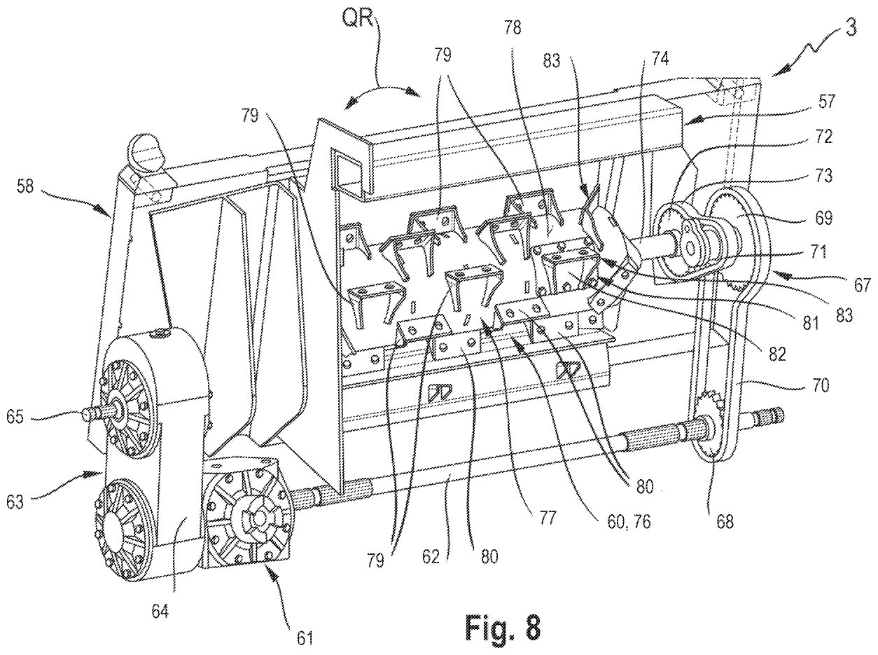

FIG. 8 schematically portrays a perspective view of the adapter unit 3 from the rear. In one or some embodiments, the intermediate conveyor 60 is driven using a mechanical chain drive 67. As shown in the figures, the chain drive 67 has two stages. In particular, the chain drive 67 may comprise a first stage with two sprockets 68, 69, a lower sprocket 68 and an upper sprocket 69, with different numbers of teeth, which are connected by a drive chain 70. The upper sprocket 69 may drive, using a shaft, another sprocket 71 of the second stage of the chain drive 67. The sprocket 71 may drive, using a drive chain 73, another sprocket 72. The sprocket 72 may be non-rotatably arranged or positioned on a drive shaft 74 of the intermediate conveyor 60. The output shaft 62 of the angular gear 61 may drive the lower sprocket 68 of the first stage, which may be arranged in a rotationally fixed manner thereupon. A chain tensioning device may generate the chain tension required for the first stage of the chain drive 67, which is illustrated by the indicated deflection of the drive chain 70 in FIG. 8.

In one or some embodiments, the intermediate conveyor 60 is designed as a paddle drum 76. The intermediate conveyor 60 may convey harvested material in an undershot manner (e.g., rotates in a counter-clockwise direction). The paddle drum 76 may comprise a circular cylindrical hollow body 77, which may be arranged or positioned on the drive shaft 74 in a rotationally fixed manner. Over its circumference, the hollow body 77 may have carrier elements 79 distributed on its circumferential surface 78, which carrier elements may extend sectionally in a radial direction beyond the circumferential surface 78 of the hollow body 77. The carrier elements 79 in the inner region of the circumferential surface 78 may be arranged or positioned spaced apart from one another in the axial direction. In the two outer edge regions of the circumferential surface 78, carrier elements 83 may be arranged at an angle to the direction of rotation, which flank the carrier elements 79 arranged or positioned in the intermediate inner region of the circumferential surface 78.

In one or some embodiments, plate-shaped wear elements 80 may be detachably attached to the carrier elements 79 and 83. In one or some embodiments, the wear elements 80 may be attached to the carrier elements 79 by screw connections. The carrier elements 79 may have planar sections on which the wear elements 80 are arranged or positioned. In the axial direction, the planar sections of the carrier elements 79 may extend substantially axially parallel to the longitudinal axis of the hollow body 77. In the radial direction, the planar sections of the carrier elements 79 may be inclined in the direction of rotation of the paddle drum 76. Due to the backward inclined arrangement of the carrier elements 79, or respectively of the wear elements 80 fixed thereon, an improved supply of the harvested material to the feed means 5 of the harvester may be achieved. In particular, the carrier elements 79 may be arranged or positioned in a staggered manner when viewed in the circumferential direction. The planar sections of the carrier elements 83, which may also serve to receive a wear element 80, may have an inclination directed from the outside inwards towards the center of the through-hole (or other type of passage) of the stationary frame element 57. The inclined carrier elements 83 may allow the harvested material located in the adapter unit 3 to be actively carried along by the paddle drum 76 also in the edge regions, and at the same time conveyed inwards towards the center of the through-hole in the stationary frame element 57.

In one or some embodiments, the detachably attached plate-shaped wear elements 80 may be adapted to different harvesting conditions. Therefore, when harvesting types of crops that have a low abrasiveness, wear elements 80 that are made of a less expensive material may be used. Accordingly, when harvesting types of crops having a high abrasiveness, wear elements 80 distinguished by a higher wear resistance may be used. In order to adjust the rotational speed of the intermediate conveyor 60, the purely mechanical drive of the intermediate conveyor 60 may require the exchange of the sprockets 68, 69 and/or 71, 72 in order to set different transmission ratios. Alternative embodiments for driving the intermediate conveyor 60 are contemplated.

In one or some embodiments, the carrier elements 79 may be non-detachably connected to the circumferential surface 78 of the hollow body 77, for example by a welded connection. In order to simplify the assembly and disassembly of the paddle drum 76, at least one overhaul element 81 detachably arranged or positioned on the circumferential surface 78 may be provided. The at least one overhaul element 81 may be detachably fixed to the circumferential surface 78 using a substantially cuboidal bottom plate 82, such as by using screw connections. A carrier element 79 may be welded onto the bottom plate 82 (or base plate) of the overhaul element 81 and may support a wear element 80. By detaching the at least one overhaul element 81 from the circumferential surface 78, the interior of the paddle drum 76 is accessible in order to detach fastening means inside the paddle drum 76 from the drive shaft 74. The paddle drum 76 may then be pulled out of the stationary frame element 57.

The individual carrier elements 79, 83 themselves may have a smooth outer edge shape, or may be formed with a plurality of serrated or U-shaped outer edges that may more optimally grip the various types of harvested material. In this regard, the carrier elements 79, 83 may be arranged or positioned with a uniform edge shape on the paddle drum 76 or in combination with other edge shapes to optimize the flow of harvested material.

Various embodiments of the invention are contemplated as shown in the following listing of claims:

Claim 1: A self-propelled forage harvester (1), comprising a mounting device (4) having a feed means (5) for harvested material (19), wherein an adapter unit (3) is detachably positioned on the mounting device (4), which adapter unit (3) is configured to mount and adapt an attachment (2) designed for a combine harvester, characterized in that the adapter unit (3) comprises a control and regulating module (34) which is configured to carry out control and regulating functions specific to the combine harvester for setting operating parameters of the mounted attachment (2).

Claim 2: A self-propelled a forage harvester (1) according to claim 1, characterized in that the control and regulating module (34) is configured to actuate the electrically and/or hydraulically operated or driven functional elements (50) of the attachment (2) and/or the adapter unit (3).

Claim 3: A self-propelled forage harvester (1) according to claim 1 or 2, characterized in that a singular coupling device (43) is arranged on the adapter unit (3) and is configured for the common hydraulic and electrical connection of the control and regulating module (34) to the attachment (2).

Claim 4: The self-propelled forage harvester (1) according to one of claims 1 to 3, characterized in that the control and regulating module (34) is configured for connection to a hydraulic system (16) of the forage harvester (1).

Claim 5: The self-propelled forage harvester (1) according to one of the prior claims, characterized in that the control and regulating module (34) is connected by at least one line (41) to at least one control command generating device (42) of the forage harvester (1).

Claim 6: The self-propelled forage harvester (1) according to one of the prior claims, characterized in that the control and regulating module (34) is configured to receive and evaluate sensor signals from at least one sensor (30) arranged on the attachment (2).

Claim 7: The self-propelled forage harvester (1) according to claim 6, characterized in that the control and regulating module (34) is configured to generate control commands depending on the evaluation of the sensor signals, and to transmit them to at least one of the functional elements (50) arranged on the adapter unit (3) and/or on the attachment (2) in order to control it.

Claim 8: The self-propelled forage harvester (1) according to claim 6 or 7, characterized in that the control and regulating module (34) is configured to generate control commands depending on the evaluation of the sensor signals, and to transmit them to a control device (13) of the forage harvester (1) which is configured to automatically steer the forage harvester (1) along a crop edge and/or at least one crop row.

Claim 9: The self-propelled forage harvester (1) according to one of claims 2 to 8, characterized in that the attachment (2) comprises a central segment (45) and at least two outer segments (46) which are articulated to the central segment (45), wherein the outer segments (46) are pivotable about substantially horizontally extending pivot axes (47) by means of functional elements (50) designed as linear actuators (44), wherein the control and regulating module (34) is configured to actuate the linear actuators (44) of the multi-part attachment (2) in order to switch the pivotable segments (46) of the attachment (2) alternately between a unfolded working position and a folded transport position.

Claim 10: The self-propelled forage harvester (1) according to one of claims 2 to 9, characterized in that the control and regulating module (34) is configured to actuate functional elements (50) arranged on the adapter unit (3) and designed as linear actuators (48) for adapting a transverse inclination and/or a longitudinal inclination of the attachment (2).

Claim 11: The self-propelled forage harvester (1) according to one of the preceding claims, characterized in that the attachment (2) to be adapted may be configured to harvest corn, wherein the attachment (2) has a plurality of infeed and picking devices (20), each comprising a picking gap (25) formed by two spaced picking plates (26, 27), picking rollers (23, 24) arranged in pairs below the picking gap (35) and driven in opposite directions, and a chopping device (28) arranged below the picking rollers (23, 24).

Claim 12: The self-propelled forage harvester (1) according to claim 10, characterized in that the control and regulating module (34) is configured to actuate a functional element (50) designed as a picking plate adjuster (29) to change the width of the picking gap (25).

Claim 13: The self-propelled forage harvester (1) according to claim 10 or 11, characterized in that the control and regulating module (34) is configured to actuate functional elements (50) of the chopping devices (28) designed as drive means (33).

Claim 14: The self-propelled forage harvester (1) according to one of claims 2 to 13, characterized in that the functional elements (50) of the attachment (2) and the adapter unit (3) may be operated or driven entirely electrically, and the control and regulating module (34) is configured to actuate these functional elements (50) entirely electrically.

Claim 15: The self-propelled forage harvester (1) according to one of the prior claims, characterized in that the control and regulating module (34) has a data interface (54) for transferring software modules to a memory unit (53) of the control and regulating module (34), by means of which the control and regulating functions may be adapted to different types of attachments (2).

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Forage harvester
2 Attachment
3 Adapter unit
4 Mounting device
5 Feed means
6 Feed roller
7 Feed roller
8 Outlet opening
9 Hydraulic cylinder
10 Opening
11 Feed housing
12 Chopping device
13 Control device
14 Post-accelerator
15 Discharge chute
16 Hydraulic system
17 Drive device
18 Picking device
19 Harvested material
20 Feed and picking device
21 Divider hood
22 Cross-feeding screw conveyor
23 Picking roller
24 Picking roller
25 Picking gap
26 Picking plate
27 Picking plate
28 Chopping device
29 Picking plate adjuster
30 Sensor
31 Blade
32 Blade holder
33 Picker gear
34 Control and regulating module
35 Valve block
36 Hydraulic feedline
37 Hydraulic discharge line
38 Signal line
39 Hydraulic feedline
40 Hydraulic discharge line
41 Signal line
42 Device
43 Coupling device
44 Linear actuator
45 Central segment
46 Outer segment
47 Pivot axis
48 Linear actuator
49 Linear actuator
50 Functional element
51 Axis
52 Computing unit
53 Memory unit
54 Data interface
55 Processor
56 Memory
57 Frame element
58 Frame element
59 Side wall
60 Intermediate conveyor
61 Angular gear
62 Output shaft
63 Gearbox
64 Housing
65 Output shaft
66 Pendulum axis
67 Chain drive
68 Sprocket
69 Sprocket
70 Drive chain
71 Sprocket
72 Sprocket
73 Drive chain
74 Drive shaft
75 Change tensioning device
76 Paddle drum
77 Hollow body
78 Circumferential surface
79 Carrier element
80 Wear element
81 Overhaul element
82 Base plate
83 Carrier element
84 Forage harvester connector
85 Attachment connector
86 Touch screen
V Direction of travel
LR Longitudinal direction
QR Transverse direction

1. An adapter unit comprising:
a forage harvester connector configured to detachably connect to a mounting device of a self-propelled forage harvester, wherein the mounting device including a feeder for harvested material to be processed by the forage harvester;
an attachment connector configured to detachably connect to an attachment, wherein the attachment is designed for operation with a combine harvester; and
a control and regulating module configured to perform one or both of control and regulating functions tailored to the combine harvester for setting operating parameters of the attachment in order for the attachment to operate in combination with the forage harvester.

2. The adapter unit of claim 1, wherein the control and regulating module is configured to actuate one or both of electrically or hydraulically operated or driven functional elements of one or both of the attachment or the adapter unit.

3. The adapter unit of claim 2, wherein the attachment connector comprises a singular coupling device configured for a common hydraulic and electrical connection of the control and regulating module to the attachment.

4. The adapter unit of claim 3, wherein the forage harvester connector is configured for connection to a hydraulic system of the forage harvester.

5. The adapter unit of claim 1, wherein the control and regulating module, via the forage harvester connector, is connected by at least one line to at least one control command generating device of the forage harvester.

6. The adapter unit of claim 5, wherein the control and regulating module, via the attachment connector, is configured to receive and evaluate one or more sensor signals from at least one sensor positioned on the attachment.

7. The adapter unit of claim 6, wherein the control and regulating module is configured to:
responsive to evaluating the one or more sensor signals, generate one or more control commands; and
transmit the one or more control commands to at least one functional element positioned on one or both of the adapter unit or on the attachment in order to control the at least one functional element.

8. The adapter unit of claim 7, wherein the control and regulating module (34) is further configured to transmit the one or more control commands to a control device of the forage harvester to automatically control at least one aspect of the forage harvester.

9. The adapter unit of claim 8, wherein the one or more commands transmitted to the control device are configured to automatically steer the forage harvester along one or both of a crop edge or at least one crop row.

10. The adapter unit of claim 2, wherein the attachment comprises a central segment and at least two outer segments which are articulated to the central segment;
wherein the outer segments is configured to pivot about substantially horizontally extending pivot axes using one or more functional elements configured as one or more actuators; and
wherein the control and regulating module is configured to actuate the one or more actuators of the attachment in order to switch the outer segments of the attachment alternately between an unfolded working position and a folded transport position.

11. The adapter unit of claim 10, wherein the control and regulating module is configured to actuate the one or more actuators in order to modify one or both of a transverse inclination or a longitudinal inclination of the attachment.

12. The adapter unit of claim 1, wherein the control and regulating module is further configured to receive sensor data indicative of a position of the attachment or a command from the forage harvester; and
responsive to receiving the sensor data indicative of the position of the attachment or the command from the forage harvester, the control and regulating module is configured to actuate the one or more actuators in order to modify the one or both of a transverse inclination or a longitudinal inclination of the attachment.

13. The adapter unit of claim 12, wherein the one or more actuators are resident on the adapter unit.

14. The adapter unit of claim 12, wherein the one or more actuators are resident on the attachment.

15. The adapter unit of claim 1, wherein the attachment is configured to harvest corn;
wherein the attachment includes a plurality of infeed and picking devices, each comprising a picking gap formed by two spaced picking plates, picking rollers arranged in pairs below the picking gap and driven in opposite directions, and a chopping device arranged below the picking rollers; and
wherein the control and regulating module is configured to modify at least one aspect of the plurality of infeed and picking devices.

16. The adapter unit of claim 15, wherein the control and regulating module is configured to actuate a functional element designed as a picking plate adjuster in order to modify a width of the picking gap.

17. The adapter unit of claim 15, wherein the attachment further includes a chopping device positioned below the picking rollers; and
wherein the control and regulating module is configured to actuate one or more functional elements of the chopping devices designed as a driver.

18. The adapter unit of claim 1, wherein functional elements of the attachment and the adapter unit are configured to be operated or driven entirely electrically; and
wherein the control and regulating module is configured to actuate the functional elements entirely electrically.

19. The adapter unit of claim 1, wherein the control and regulating module includes a data interface configured to transfer one or more software modules to a memory unit of the control and regulating module; and
wherein the one or more software modules are configured for different types of attachments; and
wherein the one or more software modules, when executed by the control and regulating module, are configured to control the different types of attachments.

20. A self-propelled harvester and adapter unit comprising:
the self-propelled harvester including a mounting device having a feeder for harvested material; and
the adapter unit configured to detachably connect to the mounting device and to mount and adapt an attachment designed for a combine harvester, wherein the adapter unit comprises a control and regulating module configured to perform control and regulating functions to the combine harvester for setting operating parameters of the attachment.
